(19) United States
(12) Patent Application Publication
(10) Pub. No.: US 2005/0002738 A1
(43) Pub. Date: Jan. 6, 2005

(54) Method for cutting undersea pipeline to length

(75) Inventor: Gerry Quinn, Katy, TX (US)

Correspondence Address: OSTROLENK FABER GERB & SOFFEN, 1180 AVENUE OF THE AMERICAS, NEW YORK, NY, 100368403, US

(73) Assignee: Coflexip S.A.

(21) Appl. No.: 10/613,570

(22) Filed: Jul. 3, 2003

Related U.S. Application Data
(60) Provisional application No. 60/465,249, filed on Apr. 24, 2003.

(51) Int. Cl. F16L 1/00; B63B 35/03

(52) U.S. Cl. 405/154.1; 405/158; 405/168.1

(57) ABSTRACT

A pipeline is laid from a first position to a second position with a connector at [[said]] the second position for connection to a subsea structure, at a depth L. A [[a]] first seabed transponder is installed on the centerline at the second position; a second seabed transponder is installed on the centerline upstream from the first transponder at a distance D3 greater than L; the first and second seabed transponders are located to determine the [[exact]] distance separating [[said]] the first and second seabed transponders; a first pipe transponder is attached on the pipeline and the pipeline is laid at the first position so that it will land close to the second seabed transponder; the second seabed transponder and the first pipe transponder are located to establish the [[exact]] distance between them; the distance is compared with the distance separating the first and second seabed transponders to calculate the remaining length of pipeline required to reach the second position.

### CROSS-REFERENCE TO RELATED APPLICATION

The present patent disclosure is based upon and claims priority of U.S. Provisional Application Ser. No. 60/465,249 filed Apr. 24, 2003, the disclosures of which are incorporated by reference.

### BACKGROUND OF THE INVENTION

1. Field of the Invention

The present invention concerns the offshore laying of rigid pipeline on the seabed from a surface vessel and more particularly, a method for accurately determining the moment at which the pipeline has to be cut so that its end will land on the seabed in the target position defined by the client.

2. Description of Related Art

Pipelines are used to convey product between a first structure on the seabed and a second structure. When the second structure is located on the surface of the sea, these pipelines are called risers. When the second structure is located on the seabed, these pipelines are called flowlines. The present invention concerns more particularly the laying of flowlines.

FIGS. 1-3 show a known method. Flowlines are laid on the seabed from a surface vessel. The flowline is laid from the vessel at an angle of about 10° to 60° from the vertical depending on the laying method, the water depth, the metoceanic conditions and the characteristics of the flowline. It gently curves until it touches the seabed at the so-called Touch Down Point (TDP). The pipeline has a catenary shape. The suspended pipe catenary has a length L.

The length L is obviously greater than the water depth WD. The lateral offset D between the vertical of the vessel and the TDP is generally about 500 ft to 3,000 ft (depending on the water depth) and a typical water depth can be up to 10,000 ft.

The structure on the seabed is usually a wellhead, manifold, riser base, etc. The flowline can be connected to this structure by two different methods: the horizontal connection and the vertical connection.

The horizontal connection consists in after having laid the flowline on the seabed, pulling its end to the horizontal flange of the seabed structure and then connecting the pipeline end to the structure.

The vertical connection consists in first laying the flowline on the seabed. The flowline comprises at each end a Pipe Line End Terminal (PLET). The PLET consists, in its simplest form, of an elbow pipe having a vertical flange for connection to the vertical flange of the seabed structure.

To connect these two vertical flanges together, a U spool (jumper) is used to connect these two flanges. The flowline can also comprise an in-line tee (also called an in-line sled) for midline connection to a third subsea structure.

Whatever the method to be used for connecting the flowline to a subsea structure, in order to make a connection to a subsea structure, the flowline needs to be cut on the vessel at a correct time and the connection means (such as PLET, flange or inline sled) welded to the flowline, so that the connection means will be positioned accurately on the seabed in the target position defined by the client and ready for connection to the subsea structure. The target position is generally a 10×10 to 15×15 ft square area (to be compared with the thousands feet of lateral offset and water depth). It is consequently necessary to accurately know the position of the flowline on the seabed and around the connection area to determine at what time the flowline has to be cut on the vessel so that its connection means will land in the target position.

This requirement for the correct positioning in the target position defined by the client is particularly important in the vertical connection system, where the jumper is designed and built prior to the laying operation. Should the pipe connection means not be positioned in the target position, the jumper will have to be modified, which delays the completion of the project.

The known method consists in determining the exact position (two coordinates) of the pipe end at the TDP where it first touches the seabed and comparing it with the known coordinates of the target position to determine at what moment to cut the flowline and weld the connection.

On the seabed, a first array of 6 seabed transponders are arranged around the target position. A second array are arranged on the seabed around the predicted TDP upstream from the target position at a distance D′ greater than L. If need be, an intermediate transponder can be arranged in between the two arrays for allowing communication between them.

To be able to determine the exact position of the flowline on the seabed, the exact position of these seabed transponders must be known. In order to do so, the survey vessel determines exactly the position of two seabed transponders per array and then based on these two known seabed transponders, is able by interrogating the seabed transponders to determine the exact position of the other seabed transponders by comparing the distance separating them from each other. Installation of the seabed transponders and determination of their positions normally can take about two days and will require a survey vessel.

Then 3 pipe transponders are attached to the pipe so as to land within the second array of seabed transponders. When the pipe transponders land on the sea bed, a survey vessel (not shown) interrogates the seabed transponders of the second array and the pipe transponders in a relative mode to determinate the length separating each of the seabed transponders from the pipe transponders. When all the lengths are known, the exact position of the pipe transponders on the seabed is accurately known. To know the exact coordinates of a pipe transponder, requires the use of at least two seabed transponders. Preferably, three pipe transponders and six seabed transponders are used for redundancy and double checking purposes.

With the exact position of the pipe transponder(s), it is possible to determine the remaining length of flowline required to reach the target position by comparing the coordinates of the target position with the coordinates of the pipe transponders.

When this remaining flowline length is reached, the flowline is cut on the laying vessel, the connection means is welded to the flowline and a fourth transponder (not shown) is attached to this connection means. The pipe is then dropped onto the seabed. The fourth pipe transponder is used to position accurately the pipe connection means in the target box by determining again the exact position of this fourth pipe transponder using the first array of seabed transponders and comparing the resulting coordinates with the coordinates of the target position.

This prior art method gives very good results. Unfortunately, it is time-consuming, requires an additional vessel, typically a survey vessel and requires at least 2 days of vessel work before and after laying to install and recover the seabed transponders and requires more than 16 transponders (2×6 seabed transponders and 4 pipe transponders).

### SUMMARY OF THE INVENTION

The present invention relates to a new method for determining the length at which to cut the flowline for welding of the connection means. It reduces dramatically the number of required transponders and the time required to install and recover the transponders.

A central difference between the previous method and the present invention is that the previous method determines the exact position of the pipe transponders and then derives the required remaining length, which requires a large number of transponders (at least two seabed transponders to determine the exact coordinates of the pipe transponders and for redundancy reasons, preferably an array of 6 seabed transponders), while with the invention, only the distances separating the seabed transponders and the pipe transponders are measured and compared to establish this remaining length.

It is possible to determine this length using only the distance separating the different transponders, as both seabed and pipe transponders are arranged on the pipelay route centerline rather than around the pipelay route as in the previous method.

Other features and advantages of the present invention will become apparent from the following description of embodiments of the invention which refers to the accompanying drawings.

### BRIEF DESCRIPTION OF THE DRAWINGS

FIG. 1 illustrates schematically the basic elements of a prior art method.

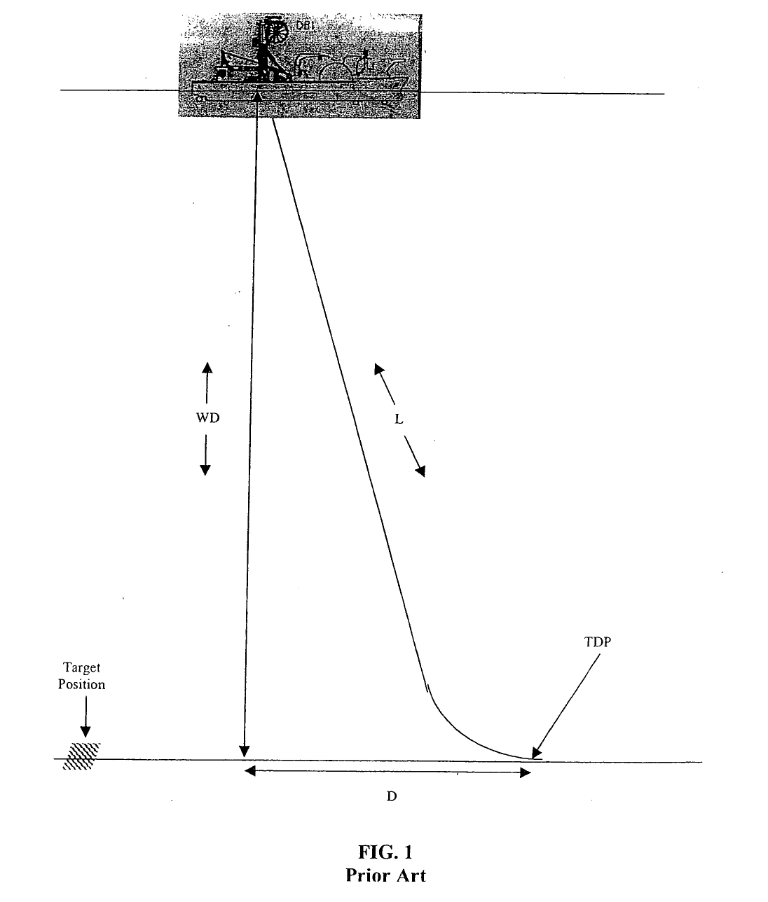

FIG. 2 illustrates the layout of seabed transponders in the prior art method.

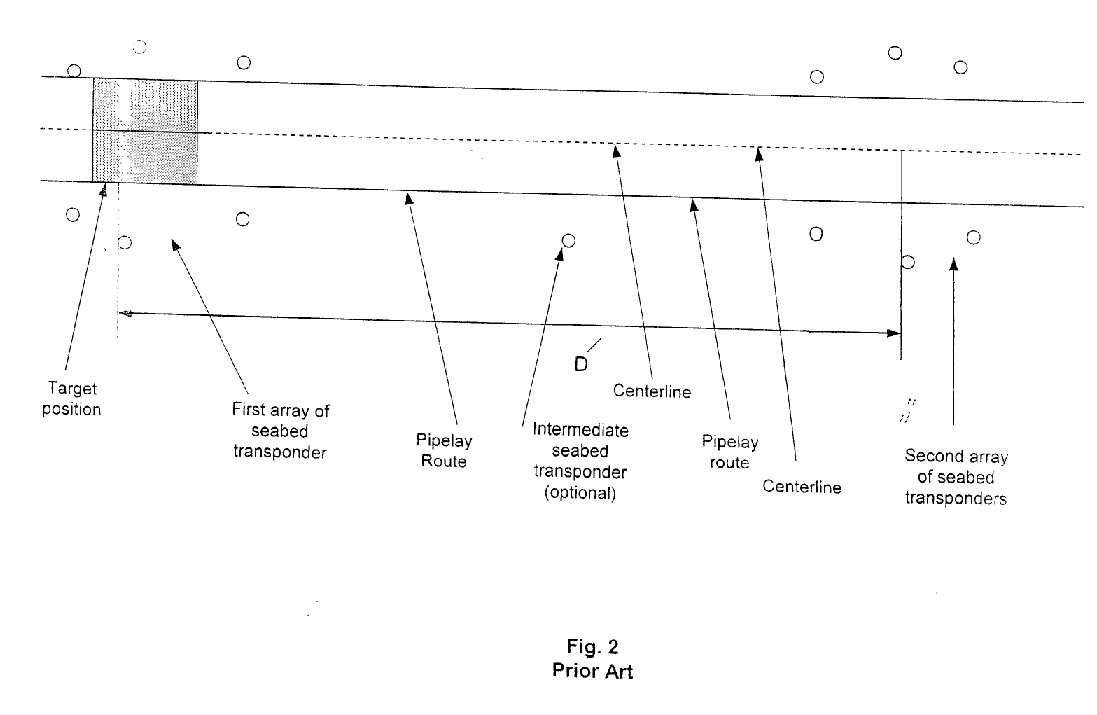

FIG. 3 shows the relative positions of pipeline transponders and seabed transponders in the prior art method.

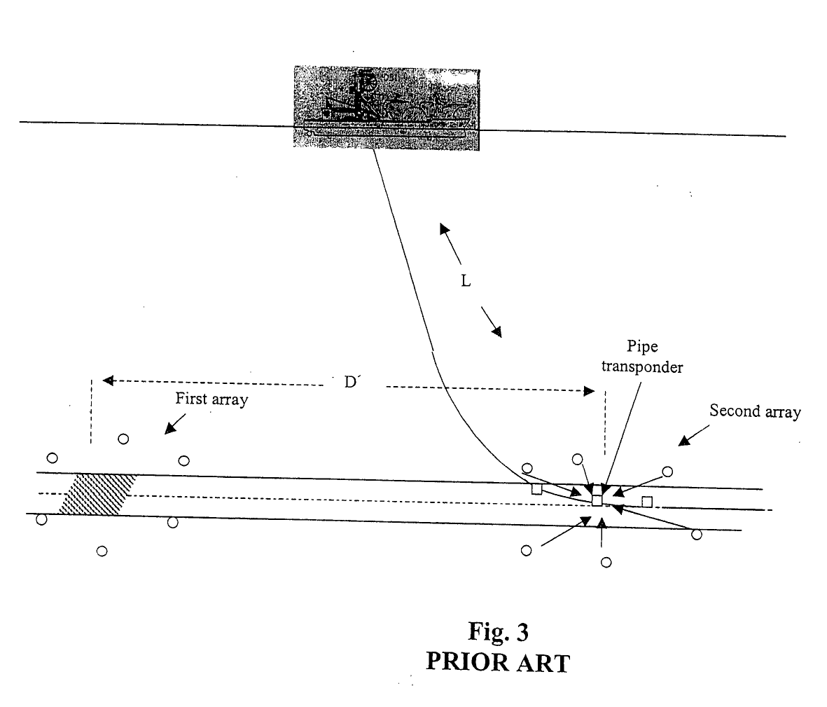

FIG. 4 illustrates the arrangement of seabed transponders and target position in a method according to an embodiment of the invention.

FIG. 5 shows the laying of an undersea pipeline including pipeline transponders according to the embodiment of FIG. 4.

### DETAILED DESCRIPTION OF AN EMBODIMENT OF THE INVENTION

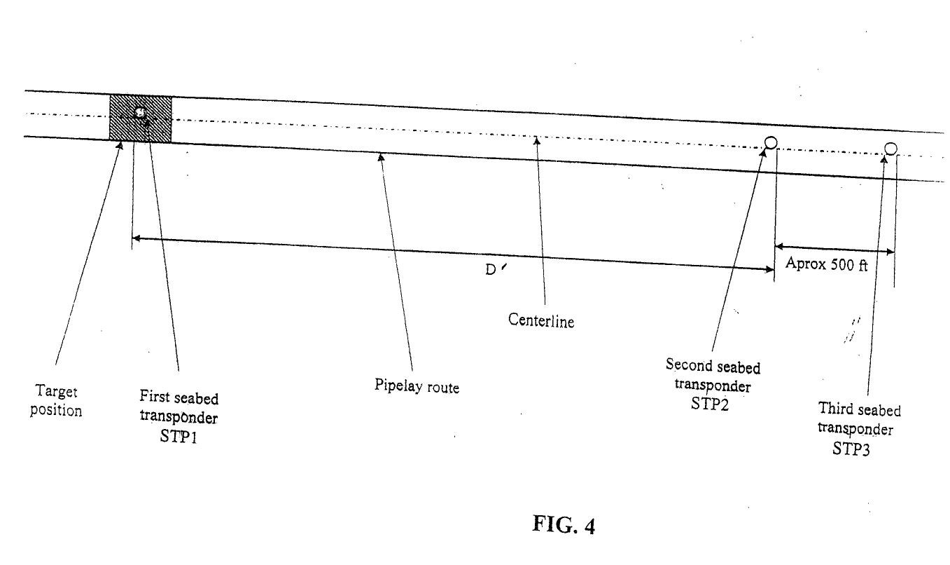

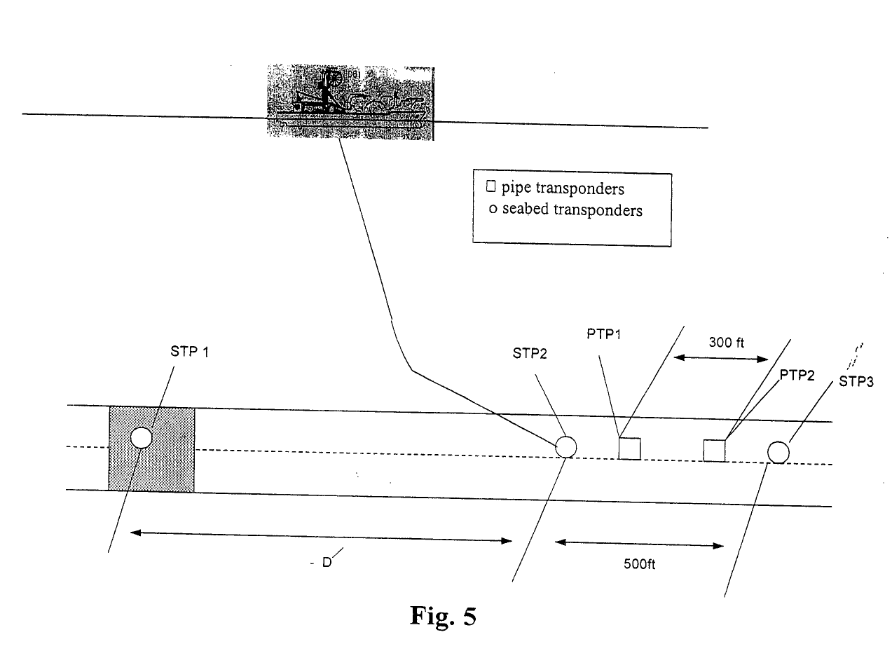

See FIGS. 4-5. A first seabed transponder STP1 is arranged on the target position, and then two (second and third) seabed transponders STP2 and STP3 are laid on the pipelay route centreline spaced from the first transponder over a length D′ greater than the catenary length L between the TDP and the surface vessel.

A vessel, preferably the laying vessel during her preparation time, installs and determines the exact positions of these 3 seabed transponders and thus the exact distances separating these seabed transponders can be calculated.

During lay approach to the target area, two (first and second) pipe transponders PTP1 and PTP2 are attached to the flowline in order to land in between the second and third seabed transponders.

A vessel, preferably the laying vessel, and more preferably the laying vessel's ROV (remote operated vehicle: underwater robot) then interrogates each of the first and second pipe transponders and second and third seabed transponders in a relative mode to establish the exact distances between them. In a preferred embodiment of the invention, it is sufficient to determine only the distance between PTP1 and STP2, and the distance between PTP2 and STP3.

Based on these distances, the surveyor on the lay vessel will calculate the required remaining length of flowline by comparing the distance between the first pipe transponder and the second seabed transponder, and the distance between the second and first seabed transponders STP2 and STP1.

The fact that the pipe transponders land on the seabed in between the second and third seabed transponder in this embodiment does not limit the invention. The pipe transponders preferably land close enough to the seabed transponders to be able to establish the length separating them, and therefore can land before or after the seabed transponders.

A third pipe transponder (not shown) is attached at the end of the flowline to ensure that the end will be correctly positioned on the seabed. However, this third pipe transponder, is not required, as long as the length is correct.

Should the flowline end land in a position laterally offset from the target box, the laying vessel during abandonment will merely have to pull up the flowline and position the flowline correctly in the target box.

Preferentially, the distance D′ between the first and second seabed transponders is greater than the length L of the suspended pipe catenary. Preferentially the distance D′ will be comprised between L+300 ft and L+700 ft. This additional distance allows the surveyor sufficient time to determine the remaining length and allows the pipelay superintendent to prepare the flowline cutting work and the connection of the pipe connection means.

Preferentially the distance separating the second and third seabed transponders is about 500 ft. Preferentially the distance separating the first and second pipe transponders is about 300 ft. An important feature is that the distance separating the second and third seabed transponders is greater than the distance separating the first and second pipe transponders.

Main advantages, as compared to the prior method, are:
fewer transponders required: 3 on the seabed and 2 on the flowline
additional vessel (survey vessel) is not required. Transponders can be installed by the laying vessel during preparation time and the laying vessel's ROV can be used to interrogate the transponders
True distances separating the different transponders are accurately known as the seabed transponders are installed on the pipeline route centreline.
As there is a seabed transponder on the target box, the distance separating the target box from the two other seabed transponders is always accurately known. In the prior art system, the seabed transponders were arranged around the target box, and around the pipeline route but none of them were arranged on the pipeline route centreline; and consequently, it was impossible to use only the distance separating a seabed transponder from a pipe transponder to establish this remaining length of pipeline.

An important difference from the prior art system is that the seabed transponders are directly arranged on the pipelay route centreline so that the distance separating the different seabed and pipe transponders can be used to establish the remaining length of pipeline needed to reach the target position.

Although the present invention has been described in relation to particular embodiments thereof, many other variations and modifications and other uses will become apparent to those skilled in the art. Therefore, the present invention is not limited by the specific disclosure herein.

1. In an offshore pipeline laying system, the pipeline being laid on the seabed by a surface laying vessel from a first position on the seabed to a second position on the seabed with a connector on the pipeline at said second position for making a connection to a subsea structure, and presenting a length L between the seabed and the laying vessel, a method for establishing the length of pipeline required to be provided from the vessel to reach the second position on the seabed, said method comprising the steps of:
installing a first seabed transponder on the pipelay route centreline at the second position;
installing a second seabed transponder on the pipeline route centerline spaced upstream from the first transponder at a distance D′ greater than L;
establishing the positions of the first and second seabed transponders so as to determine the exact distance separating said first and second seabed transponders;
attaching a first pipe transponder on the pipeline and laying the pipeline at the first position so that it will land close to the second seabed transponder;
interrogating the second seabed transponder and the first pipe transponder in a relative mode to establish the exact distance between them;
comparing the established distance with the distance separating the first and second seabed transponders to calculate the remaining length of pipeline required to reach the second position;
cutting the pipeline according to said remaining length;
welding the connector to the pipeline; and thereby
laying the pipeline to the second position with the connector being at the second position.

2. The method of claim 1, wherein the distance D′ is comprised between L+300 ft and L+700 ft.

3. The method of claim 1, wherein a third seabed transponder is arranged on the pipeline route upstream from the second seabed transponder.

4. The method of claim 3, wherein a second pipe transponder is attached to the pipeline upstream from the first pipeline transponder.

5. The method of claim 4, wherein the distance between the first and second pipe transponders is shorter than the distance between the second and third seabed transponders.

6. The method of claim 4, wherein the pipeline is laid so that the first and second pipe transponders are laid in between the second and third transponders.

7. The method of claim 1, wherein a third pipe transponder is attached adjacent the connector to help the positioning of the connector at the second position.

8. The method of claim 4, wherein said second and third seabed transponders are spaced about 500 feet apart.

9. The method of claim 8, wherein said first and second pipeline transponders are spaced about 300 feet apart.

10. The method of claim 9, wherein the pipeline is laid so that the first and second pipe transponders are laid in between the second and third transponders.

11. In an offshore pipeline laying system, the pipeline being laid on the seabed by a surface laying vessel from a first position on the seabed to a second position on the seabed, a method for establishing the length of pipeline required to be provided from the vessel to reach the second position on the seabed, said method comprising the steps of:
installing a plurality of seabed transponders along the pipelay route;
installing at least one pipe transponder on said pipeline; and
interrogating said seabed and pipe transponders,
wherein the seabed transponders are arranged sufficiently near the pipelay route centreline so that respective distances separating corresponding pairs of said seabed and pipe transponders can be used to establish the remaining length of pipeline needed to reach the second position.

12. The method of claim 11, wherein the seabed transponders are arranged on the pipelay route centreline.
